(19) United States
(12) Patent Application Publication
(10) Pub. No.: US 2015/0109436 A1
(43) Pub. Date: Apr. 23, 2015

(54) Smart Dual-View High-Definition Video Surveillance System

(71) Applicant: Safeciety LLC, Hofffman Estates, IL (US)

(72) Inventors: Shidong Chen, Hoffman Estates, IL (US); Honghui Xu, Buffalo grove, IL (US)

(73) Assignee: Safeciety LLC, Hofffman Estates, IL (US)

(21) Appl. No.: 14/061,749

(22) Filed: Oct. 23, 2013

(51) Int. Cl. H04N 7/18; H04N 19/70

(52) U.S. Cl. CPC H04N 7/183; H04N 19/70
USPC 348/143

(57) ABSTRACT

The present invention presents a smart dual-view video surveillance system, which carries a smart live-view video and a dedicated recording-view video from each camera to the video recorder. The smart live-view video only carries video data for the visible displayed pixels in its displaying video window and is dedicated for live-view monitoring. The dedicated recording-view video carries the complete video data and is dedicated to video recording and playback.

This application refers to the prior provisional application under application No. US/61,717,985 filed on Oct. 24, 2012.

### BACKGROUND OF THE INVENTION

1. Field of Invention

The present invention relates to high-definition video surveillance systems.

2. Background

In high definition (HD) video surveillance systems, typically one video recorder is connected with multiple cameras via cable networks. The data flow from camera to video recorder is called downstream, while the data flow from the video recorder to camera side is called upstream. In the video recorder, the downstream videos from cameras that capture live scenes in the field of view of cameras are displayed instantly to monitor and also recorded for future playback. The videos for instant displaying are called live-view videos and the videos for recording are called recording-view videos respectively. In some systems, the live-view video and recording-view video are two different video streams. In other systems, the same video stream is used for both live-view and recording-view.

The video recorder often uses an HD monitor to display the live view videos from multiple cameras on a single screen, with each video occupying a small area of the whole monitor screen. This monitor is called primary monitor and its screen is called primary screen. The video displaying area on the screen is called video window. In the video surveillance industry, it is common to display 4, 5, 6, 9, 10 or 16 videos on a single screen simultaneously as shown in FIG. 1. FIG. 1(f) shows a 16-split screen pattern, where 16 video windows are shown on one screen with window identity number 1, 2, . . . , 16 respectively. The 16-split screen shown is commonly used to display 16 videos on a single screen. For a monitor with the FHD (full high-definition) resolution of 1920×1080 pixels on its screen, each video window in 16-split has the size of 480×270 pixels, that is 1/16 FHD.

Consider a common example application of conventional FHD video surveillance system where 16 FHD cameras are connected to a FHD video recorder with 1 FHD monitor, and all 16 FHD source videos from 16 cameras are sent to video recorder and displayed on the FHD screen of its monitor.

In usual situations, the operator needs to see the 16 FHD video source equally simultaneously in the 16-split screen on the single FHD monitor. Each source video has FHD resolution while it is to be displayed in a video window of 1/16 FHD resolution. Clearly, the FHD source video cannot fit into a displaying video window of 1/16 FHD. Therefore, each FHD source video is always downscaled and/or cropped into a displaying video of 1/16 FHD and accordingly all 16 FHD videos are combined into 1 and then displayed on the FHD monitor screen.

In some situations, the operator needs to see the details of one or several selected source videos in video windows larger than 1/16 FHD. In order for the combined video to fit into same monitor screen, some other source videos need to be displayed in smaller video windows. It is still true that each FHD source video cannot fit into a displaying video window of different size. Therefore, each FHD source video is still downscaled and/or cropped into a displaying video of different size. Accordingly, all 16 FHD videos are combined into 1 and then displayed on the FHD monitor screen.

In some other situations, the operator needs to see the full details of one selected FHD source video on the whole FHD monitor screen. This is called full screen display. Each pixel of the selected source video is displayed as one pixel on the screen, all FHD pixels in the selected source video are displayed on the FHD monitor screen. However at same time, all other 15 FHD source videos are not displayed at all.

It can be seen from above example application that under various situations, although 16 FHD source videos are carried from cameras to video recorder, only 1 FHD display video with total 1920×1080 visible displayed pixels is produced and displayed for live view monitoring.

In order to meet the operator's requirements in various situations, the video recorder needs to have the capability of displaying the source video from each camera at varying resolution and size, from coarse resolution used to provide a whole view in a miniature sized video window on split screen mode to full resolution as used in full screen mode. To achieve this capability, the conventional system carries source video at full resolution and full size from each camera to video recorder. When the source video reaches the video recorder, the video can be downscaled and displayed on the screen with the desired resolution, such as 16-split view or full screen view, by cropping, scaling and filtering the source video.

Two conventional systems exist, which can achieve the aforementioned goals: one is the HD-SDI (High Definition Serial Digital Interface) camera based systems and the other is the HD IP (Internet Protocol) camera based systems. In both systems, each camera transmits video with full resolution from the camera side to the monitor side. The HD-SDI systems transmit uncompressed or lightly compressed high definition videos to video recorder without IP packetizing. Contrarily, the HD IP cameras transmit heavily compressed high definition videos over IP to video recorder.

Both of these systems have their own advantages and disadvantages. Since uncompressed or lightly compressed HD video is transmitted, the HD-SDI system can achieve near-zero latency lives view, which is important for time sensitive applications. However, the HD-SDI system requires huge bandwidth in video transmission and heavyweight video compression for recording and/or IP packetizing for internet access in video recorder. In IP camera based systems, while IP video is well suited for recording and internet access, the IP video is essentially not suited for live view monitoring because of the high computational cost of heavyweight decompression and the latency resulting from video compression/decompression and IP traffic handling.

There is also a common difficulty in the two systems when modern video surveillance systems migrate to high definition. As is well known, it requires a lot of computation power and hardware resources to compress or decompress and display each HD video. Further in both systems, as each camera carries an HD video to the video recorder, it becomes computationally costly for the multi-channel video recorder to compress or decompress and display a large number of HD videos, e.g., 16 HD videos, simultaneously.

Accordingly, it is desirable to combine the advantages of both systems, that is, to provide up to full resolution and full screen video with near-zero latency for liver-view in addition to IP video well suited for recording. It is also desirable to resolve the problems of HD live-view for multiple video cameras with low cost.

### SUMMARY OF THE INVENTION

The present invention presents a smart dual-view video surveillance system, which carries a smart live-view video and a dedicated recording-view video from each camera to the video recorder. The smart live-view video only carries video data for the visible displayed pixels in its displaying video window and is dedicated for live-view monitoring. The dedicated recording-view video carries the complete video data and is dedicated to video recording and playback.

In one aspect of the present invention, the system converts each source video to displayed video at camera side and only transmits the portion of video that is visible in the displaying window on the monitor screen while at the same time each video is capable of being displayed in full screen full resolution as is in existing systems.

Compared to the conventional HD-SDI based live monitoring system, the present invention reduces the total bit rate significantly required for the live-view videos from all cameras. Consider the example application above, the total number of visible displayed pixels on the monitor from all 16 cameras combined is no more than 1920×1080. Therefore, the smart live-view video only needs to carry at most 1920×1080 pixels per frame from all 16 cameras combined. In comparison, the 16 channel HD-SDI system needs 16 times the bit rate to achieve the live view monitoring.

Compared to the conventional IP based live monitoring system, the present invention reduces the decoding cost significantly required for the live-view videos from all cameras. Consider the example application above, the total number of visible displayed pixels on the monitor from all 16 cameras combined is no more than 1920×1080. Therefore, minimally 1 FHD lightweight decoder is enough to uncompress all smart live-videos from all 16 cameras. In comparison, the 16 channel IP system needs 16 heavyweight video decoders to uncompress 16 source videos from all cameras to achieve the live view monitoring. On the recording-video side, since only playback of recording video needs heavyweight decoder, and operator is used to traces back one video at a time, one heavyweight decoder may suffice the whole smart dual-video recorder. The bottleneck of video decoder in conventional IP system is thus eliminated.

In another aspect of the present invention, a method is provided to enable transmission of only the visible displayed video. A smart live-view processor uses a reliable protocol to constantly obtain from the smart video recorder the parameters such as the pan offset, tilt offset, zoom ratio, the displaying video window size, and the visibility of pixels in displaying video window. Based on such information, neither the full resolution full size frame in source videos from most cameras nor the invisible portion of the video in the displaying video window is carried in smart live-view video from the camera side to the monitor side.

In another aspect of the present invention, the live-view video uses lightweight or no compression. The live-view video can further be carried over layer 1 or 2 of OSI (Open System Interconnection) model, below IP layer to remove IP-related complexity and latency, ease installation and improve display quality. In contrast, the recording-view uses heavyweight compression to reduce the transmission data rate. The recording-view video is often carried over IP.

In another aspect of the present invention, video decoding resource in the video decoder can be shared between all the camera live-view videos and thus reduce the system cost.

### BRIEF DESCRIPTION OF THE DRAWINGS

FIG. 1 illustrates the split-screen display pattern.

FIG. 2 illustrates the popup window display.

FIG. 3 illustrates an embodiment of the smart dual-view video surveillance system.

FIG. 4 illustrates an embodiment of the smart dual-view camera.

FIG. 5 illustrates an embodiment of the smart live-view processor in smart dual-view camera.

FIG. 6 illustrates the method of implementing ePTZ and masking.

FIG. 7 illustrates an embodiment of the smart dual-view video recorder.

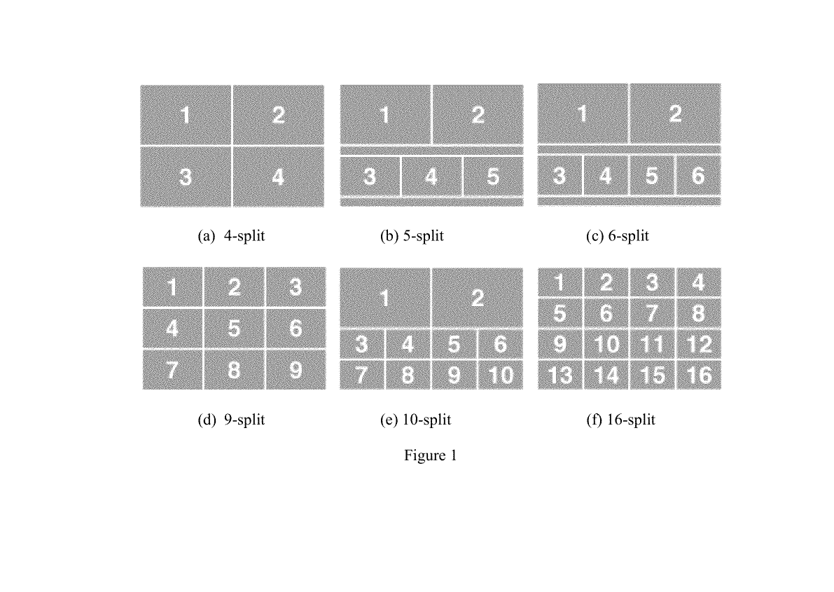

### DETAILED DESCRIPTION OF THE INVENTION

The principle and embodiments of the present invention will now be described in detail with reference to the drawings, which are provided as illustrative examples so as to enable those skilled in the art to practice the invention. Notably, the figures and examples below are not meant to limit the scope of the present invention to a single embodiment but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration

In a certain embodiment, the video surveillance systems may require the video recorder to display videos in the popup window, which displays the selected video on the top of other video windows. Such a video recorder supports multiple display layers. A video window in the upper display layer has some overlapped areas with the video window in the lower layers. The popup window size is not limited by the split-screen pattern and thus can vary from small thumbnail size to large full-screen size.

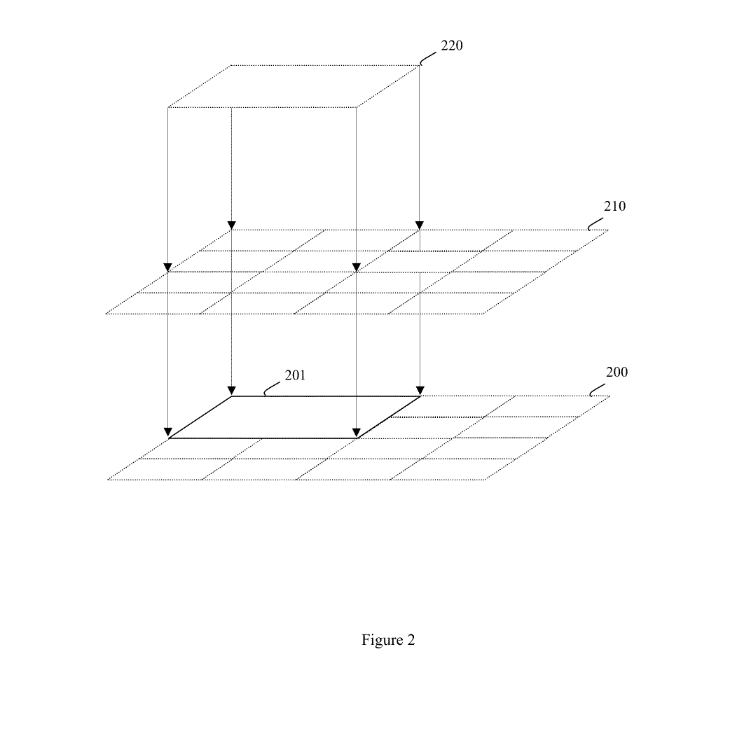

FIG. 2 illustrates an example that how all video windows are displayed on the screen by using popup window. In the example, 16 video windows display 16 live videos from 16 cameras. The 16-split screen is set on the display layer 1, labeled as 210. Above that, there is a popup video window 220. On the final display 200, the popup window 201 is overlapped with 4 split windows. The popup window 201 is 100% visible and the 4 overlapped split windows are completely invisible.

According to the principle of the present invention, the smart live-view video carries video data only for the visible displayed pixels in its displaying window. As shown in FIG. 2, the video content in the 4 invisible windows does not need to be carried from the camera to the monitor since it is never seen by the operator. In some situation, all the 16 split windows become invisible because they are covered by a full screen video. In this case, only the video data of the full screen video need to be transmitted.

In the example of FIG. 2, the overlapped video in the lower layer window is invisible on the screen. Thus, the total number of visible video pixels is not larger than the pixel number of the screen. In a certain embodiment, the videos in the overlapped popup windows are mixed together by alpha compositing to create partial or full transparency such that video content from multiple overlapped videos can be displayed on a single screen at the same time. In order to achieve alpha compositing, video pixels from all related videos have to be carried from the camera to the display monitor. Thus, the total number of visible video pixels is larger than the pixel number of the screen.

In some embodiment, one or several videos are displayed on other secondary monitors with full resolution. However, in most large scale systems, it is not necessary to display all videos in full screen full resolution.

Thus, the total number of visible video pixels on the screen is much less than that of all full resolution videos combined. For example, for 16 cameras with the resolution of 1920×1080, the monitors may only need to display 2×1920×1080 pixels on the screen for all videos, much less than 16×1920×1080 pixels contained in a frame picture of all 16 cameras combined.

Note that the present invention also transmits a recording view video under advanced heavyweight compression, whose compression ratio can reach 100:1 or even 200:1. The combined bit rate of the live-view video and the recording view video is still significantly lower than that of the traditional HD-SDI systems, where HD videos of all cameras are carried from the cameras to the monitor.

Compared to IP camera based systems, the present invention has the advantage of low latency, easy installation and better video quality. Firstly, the smart live-view video of the present invention preserves the low latency feature of lightly compressed video. The long latency in heavily compressed recording-view is well acceptable for video recording and playback video monitoring. Secondly, since the smart live-view video is not transported over IP, no complicated IP configuration and handling is required. And plug and play can be easily supported by the live-view video. These features significantly alleviate the difficulty of installation and trouble shooting. Thirdly, due to the burst nature of IP traffic and the presence of external interference, extra packet delay resulting from packet loss is common in IP video streaming. The extra delay may cause video freeze and/or video jump in the conventional network video surveillance system which relies heavily on the compressed IP stream to recover the live-view video. The video quality issues caused by IP traffic jittering are eliminated in the smart live view of the present invention, which uses no IP protocol in a certain embodiment. The play back video can have desirable quality as long as the all necessary IP packets are finally delivered and stored.

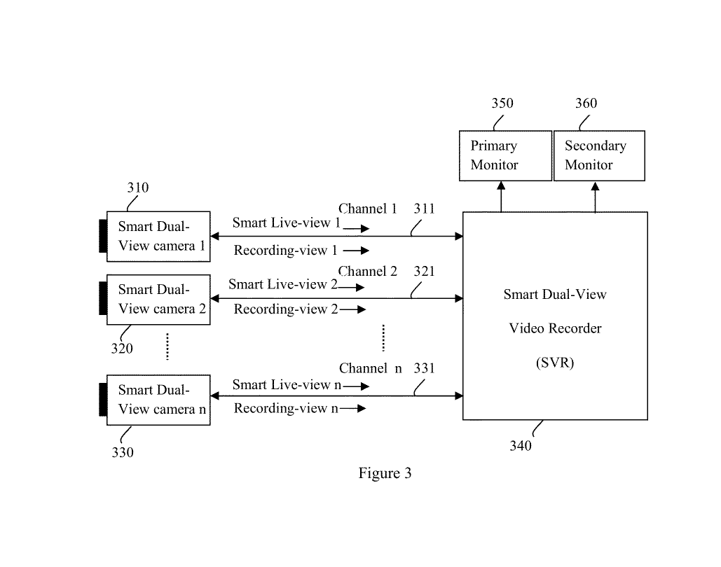

FIG. 3 shows an embodiment of the smart dual-view surveillance system, where n smart dual-view cameras, labeled as 310, 320 and 330, are connected with the smart dual-view video recorder (SVR) 340 via communication channel 311, 321 and 331. In FIG. 3, n is a positive integer. For example, n is 16 for a surveillance system with 16 cameras. The communication channels can be coaxial cable, twisted pair, fiber optical cable, power line or wireless channel. One or multiple display devices, commonly HD monitors, labeled as 350 and 360, are connected with SVR 340. Monitor 350 is the primary monitor, and monitor 360 is the secondary monitor or spot monitor. In a certain embodiment, the primary monitor displays multiple videos simultaneously, while the secondary monitor displays only one video in full screen. Both the smart live-view video and the recording-view video are carried simultaneously from each smart dual-view camera 310, 320 and 330 to the video recorder 340 over communication channel 311, 321 and 331 respectively.

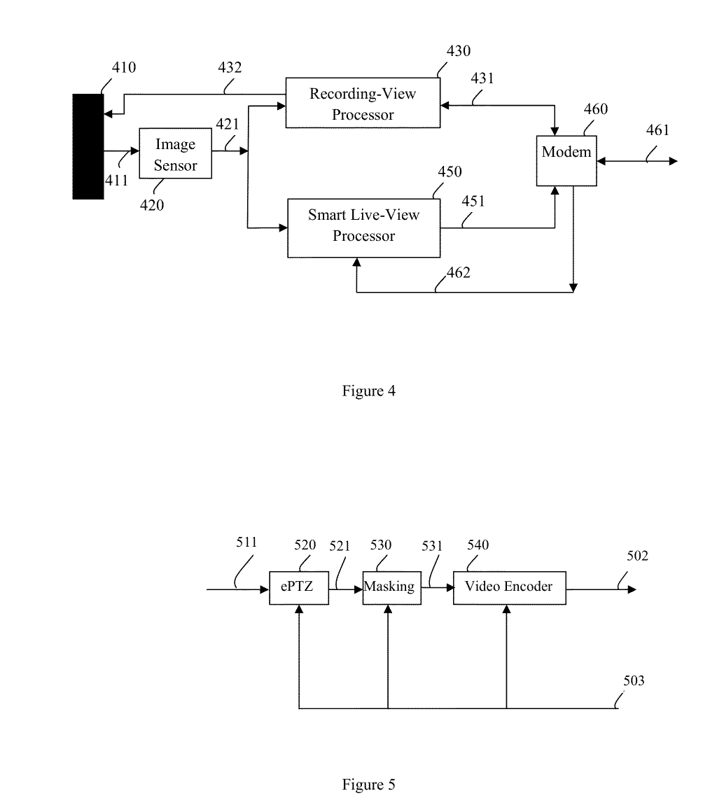

FIG. 4 shows an embodiment of the smart dual-view camera. The lens system 410 focuses the light rays 411 from an object onto the image sensor 420 and produces a raw digital video 421. The recording-view processor 430 converts the raw digital video 421 into one of its supported video formats, such as 1280×720 pixels in 24/30/60 frames per second, and 1920×1080 pixels in 24/30/60 frames per second. The recording-view processor typically includes a high quality, long latency video encoder to heavily compress the source video in the supported format. For IP cameras, the compressed recording-view video is encapsulated into IP packets and sent to the smart dual-view modem 460 by the two-way IP signal 431.

The recording-view processor 430 can send signal 432 to control the lens system. The control signal 432 may include auto-focus control, iris control and PTZ (Pan-Tilt-Zoom) control. Some control signal, such as PTZ control signal, may be originated from the SVR and may be carried over the IP packets or the separate wiring such as RS 485.

The raw digital video 421 also enters the smart live-view processor 450, which produces a live-view stream 451 carrying video data only for the visible displayed pixels in its display window according to the control signal 462. The SVR 340 is aware of the resolution, size, and visibility of the displayed video on the monitor screen. Such information is sent back to the smart live-view processor 450 via the return path of the communication channel. Cropping, scaling, masking and other techniques are applied to the raw digital video 421 to obtain a video comprising only the visible displayed pixels in the display window on the monitor screen.

In a certain embodiment, the recording-view video is streamed over IP and the live view stream is not. Thus, a hybrid camera-side modem 460 is required to carry both streams. The recording-view video and the live-view video are multiplexed together with other downstream information by the camera-side modem 460 and sent to SVR 340 over communication channel 461. Meanwhile, the camera-side modem 460 also receives the upstream signal for the recording view stream and the smart live-view controlling signal 462. Modem 460 further de-multiplexes and sends these upstream signals to the recording-view processor 430 or the smart live-view processor 450. In certain embodiment, some information included in smart live-view controlling signal may be carried over separate physical communication link. For example, the ePTZ control signal can be carried over the conventional RS-485 cable.

The details of an embodiment of the smart live-view processor 500 are shown in FIG. 5. It includes an ePTZ (electronic Pan-Tilt-Zoom) controller 520, a live-view masking block 530 and a live-view encoder 540. The ePTZ derives a displayed video 521 from the raw video 511. The displayed video 521 may contain invisible area when displayed on the monitor screen. The invisible area of the displayed 521 is further removed by the masking block 530. If one video is completely invisible on the monitor screen, no video data is carried from the camera to the SVR. The video encoder 540 further reduces the data rate by adopting some lightweight compression algorithm, such as lossless DPCM, lossy DPCM, lossless JPEG and lossy JPEG. As can be seen, the smart live-view processor can reduce the data rate significantly with ePTZ, masking and encoding.

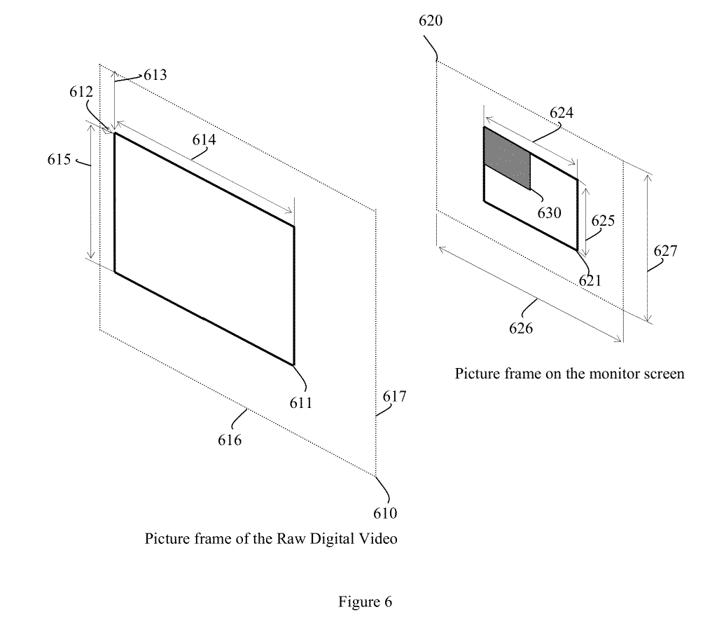

FIG. 6 shows how the ePTZ controller 520 works on every frame picture of a video. At the camera side, the raw frame picture 610 in raw digital video 511 has a width 616 and height 617 determined by the image sensor 420. The SVR determines the width 614, height 615, pan offset 612 and tilt offset 613 of the source picture 611 of the displayed video on the monitor screen. The monitor screen 621 has a width 626 and height 627. The source picture 611 is to be shown in the display window 621 on the monitor screen. The size of source picture 611 is not necessarily the same as the size of the display window 621. In order to show the picture 611 in the display window 621, the ePTZ controller firstly needs to crop the picture 611 from the raw picture 610 according to the size and offset information 612, 613, 614 and 615; secondly, the ePTZ controller needs to scale the size of the picture 611 such that the resulting picture has the same size as the display window 621. The scaling can be achieved by interpolation techniques followed by some image enhancement filters. In some embodiment, part of the functions may also be applied at the SVR side.

To reduce the required bit rate, we can remove the video content at the output of the ePTZ controller 520 in the invisible area of the displayed video. This is achieved by the live-view masking block 530. In FIG. 6, assume the gray area 630 is invisible in the display window of video 611. The masking processing block 530 erases these invisible displayed pixels in 630. The position of the mask area needs to be known by the video encoder 540. Such information is provided by the SVR. A protocol of formatting the data of a masked video needs to be known by the camera and the SVR such that the SVR can obtain the data in the right order for decoding and display. In some embodiment, the invisible displayed pixels can be simply replaced with a fixed value such as 0. The continuous fixed value only causes a small amount of overhead on the bit rate after processed by the video encoder 540. In this way, the encoding, decoding and displaying become easier since the video at the masking output is still in the regular rectangular shape. As the erased pixels in the area replaced with the fixed value are covered by the upper layer video, the video can be displayed correctly on the screen.

For the ePTZ and the masking function to work properly, the smart live-view processor 450 needs a reliable protocol to constantly obtain from the SVR the parameters such as the picture width 614 and height 615, offset 612 and offset 613, the zoom ratio of the source picture size and the displaying video window size, and the information of the invisible area. Based on such information, the information of the invisible video pixels in the display window is not carried from the camera side to the monitor side, and thus the present invention significantly reduces the total bit rate and the decoding complexity.

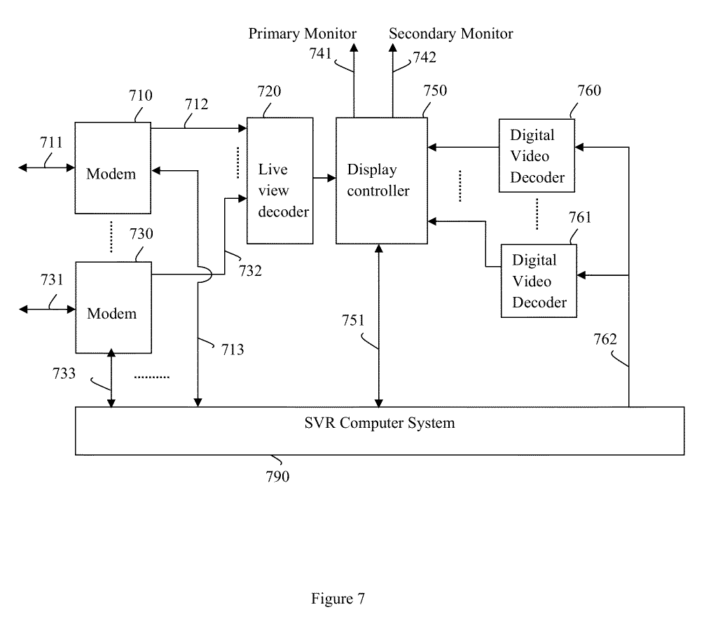

FIG. 7 shows an embodiment of the SVR, where n smart dual-view modems 710, 730 are connected with n smart dual-view cameras by channel 711, 731 respectively. The modems 710, 730 demodulate the received signal into the corresponding transmitted live-view video data and recording-view video data. At the same time, they modulate and send the upstream data, such as IP acknowledge packets, camera PTZ signal and live-view window information, to the transmission channel. The live-view video data 712, 732 are sent to the live-view decoder 720, which reconstructs the live-view videos from all the cameras. As discussed before, the total number of visible displayed pixels for live-view is much less than the total pixels of all source videos combined. It is not necessary to build a video decoder for each incoming camera video. Instead, video decoding resource can be shared between the live-view videos from all cameras. For example, in a system with 16 cameras using JPEG compression, the video decoder 720 may only need one JPEG decoder to decode live-view videos from all 16 cameras.

The modem 710, 730 may also exchange data with the computer system 790 of the SVR via signal 713, 733. The recording view video traffic from all cameras is sent to the computer system 790 for IP protocol handling and video recording. In a certain embodiment, the live-view video can also be sent to the computer system 790 and saved in the backup storage system. On the other hand, the returning IP packets and some control signal such as PTZ information may be sent to the modem 710, 730. Further, the information for live-view video, such as window position, visible area and window size, are collected from the displayer controller 750; and the computer system sends such information to the modems according to the protocol known to both the camera and the SVR.

The display controller is responsible for generating monitor display by combining the output of the live-view decoder 720 for live-view, the output of the digital video decoder 760, 761 for playback view, and the graphics signal 751 for computer graphics. The computer graphics may include company logo, text, user control buttons, split view mosaic, etc. The digital decoder 760, 761 decodes the recording-view videos stored in the computer system 790 for playing back previously stored scenes. Since the recording-view may be in HD format, the digital decoder 760, 761 are the costly HD decoders. With a powerful display controller, live-view video, playback view, and computer graphics can be combined and displayed in the primary and/or the secondary monitors in various forms with various features, such as split view, popup view and alpha compositing.

The display controller also maintains the video window information, such as video position, video size, overlapped area, visibility of the overlapped area and video zoom ratio. Such information is usually generated by the computer system according to the input from the operator. In some embodiment, touch screen monitor is used and the display controller obtains the video window information from the monitors 741 and 742. The video window information is processed by the computer system and sent back to the camera side according to the predefined protocol. Each camera receives its own display window information and generates the live-view video accordingly.

The present invention is described according to the accompanying drawings. It is to be understood that the present invention is not limited to such embodiments. Modifications and variations could be effected by those skilled in the art without departing from the spirit or scope of the invention as defined in the appended claims.

What is claimed is:

1. A camera that produces a smart live-view video and a dedicated recording-view video and transmits both videos to the video recorder, comprises:
a recording-view processor that receives a raw digital video from image sensor and produces a recording-view video;
a smart live-view processor that also receives a raw digital video from image sensor and produces a smart live-view video; and
a modem that receives both recording-view video and smart live-view video, combines both videos and sends to the combined video to the video recorder.

2. The camera of claim 1, wherein the recording-view video is a video that carries the video data for all pixels of its designated frame size and is dedicated to be used in video recording and playback.

3. The camera of claim 1, wherein the recording-view video is heavily compressed by recording-view processor, has low bit rate per pixel, and incurs long end-to-end latency.

4. The camera of claim 1, wherein the recording-view video is carried over IP (Internet Protocol) layer or the layers above IP layer in the Open System Interconnection model.

5. The camera of claim 1, wherein the smart live-view video is a video that only carries video data for the visible displayed pixels in the displaying video window for this video on monitor screen and is dedicated for live-view monitoring.

6. The camera of claim 1, wherein the smart live-view video is lightly compressed by the smart live-view processor or uncompressed, has high bit rate per pixel, and incurs low end-to-end latency.

7. The camera of claim 1, wherein the smart live-view video is carried over various layer of the Open System Interconnection model, including but not limited to physical layer, MAC layer, IP layer or the layer above IP layer.

8. The camera of claim 1, wherein the recording-view video and the smart live-view video are essentially isochronous.

9. The camera of claim 1, wherein the modem also receives the recording-view upstream signal from the video recorder, and sends the received recording-view upstream signal to the recording-view processor.

10. The camera of claim 1, wherein the modem also receives the smart live-view controlling signal from the video recorder, and sends the received the smart live-view controlling signal to the smart live-view processor.

11. The camera of claim 1, wherein the modem uses one or multiple physical communication channels to carry all downstream and upstream signals, wherein the physical communication channels includes but are not limited to Ethernet, RS-485.

12. The camera of claim 1, wherein the smart live-view processor also uses a reliable protocol to constantly obtain from the video recorder the controlling parameters, including but not limited to the pan offset, tilt offset, zoom ratio, the displaying video window size, and the visibility of pixels in displaying video window.

13. The camera of claim 6, wherein depending on the said controlling parameters, the smart live-view carries no pixels, some pixels, or all pixels of displayed video that is converted from its digital raw video input for its displaying video window.

14. The camera in claim 1, where the smart live-view processor that converts the digital raw video into the displayed video for its displaying video window, and encodes the visible pixels in the displaying video window into the smart live-view video, further comprises:
an ePTZ controller that performs electronic Pan-Tilt-Zoom (ePTZ) based on the ePTZ controlling parameters in the controlling parameters and converts the digital raw video into a displayed video;
a live-view masking block that removes the pixel data of the invisible displayed pixels from the displayed video and obtains the masked displayed video; and
a live-view encoder that only encodes the active pixels in masked displayed video into smart live-view video.

15. The camera of claim 14, wherein the ePTZ controller selects a portion of frame picture in digital raw video to be converted into the frame picture of displayed video that is to be displayed in its video window on monitor screen, regardless of the visibility of the displayed pixels.

16. The camera of claim 14, wherein the ePTZ controller shifts the selected portion of frame picture in digital raw video horizontally depending on the pan offset included in controlling parameters, shifts the selected portion of frame picture in digital raw video vertically depending on the tilt offset included in controlling parameters, and scales the selected portion of frame picture in digital raw video into size of its displaying video window depending on the zoom ratio and the size of its displaying video window included in controlling parameters.

17. The camera of claims 15 and 16, wherein the ePTZ controller passes the original full size full resolution digital raw video if the pan offset is 0, tilt offset is 0 and zoom ratio is 1:1. The camera of claim 18, wherein a live-view masking block that either marks each visible pixel as active pixel and each invisible pixel as inactive pixel in the displayed video, or replaces the pixel value of invisible pixels with specific pattern, such as a constant 0, and mark visible pixels and invisible pixels as active pixels;

18. The camera of claim 14, wherein the live-view encoder adopts either no compression, or a lightweight compression algorithm including but not limited to lossless DPCM, lossy DPCM, lossless JPEG and lossy JPEG to reduce the bit rate of smart live-view video.

19. A method to produce the smart live-view video, comprises:
at video recorder, generating and constantly updating the controlling parameters such as the pan offset, tilt offset, zoom ratio, the displaying video window size, and the visibility of pixels in displaying video window are generated and constantly updated based system settings and operator's input;
sending the controlling parameters in upstream signal from the video recorder to the smart live-view processor in each camera;
at the ePTZ controller, selecting a portion of frame picture in digital raw video to be converted into the frame picture of displayed video, which is to be displayed in its video window on monitor screen, regardless of the visibility of the displayed pixels;
at the ePTZ controller, horizontally shifting the selected portion of frame picture in digital raw video depending on the pan offset included in controlling parameters;
at the ePTZ controller, vertically shifting the selected portion of frame picture in digital raw video depending on the tilt offset included in controlling parameters;
at the ePTZ controller, scaling the selected portion of frame picture in digital raw video into the size of its displaying video window depending on the zoom ratio and the size of its displaying video window included in controlling parameters;
at the live-view masking block, marking the visible pixels in the displayed video from ePTZ controller as active pixels, and marking the invisible pixels in the displayed video from ePTZ controller as inactive pixels;
at the live-view encoder, either passing all active pixels as uncompressed or encoding all active pixels by adopting a lightweight compression algorithm, including but limited to lossless DPCM, lossy DPCM, lossless JPEG or lossy JPEG, to reduce the bit rate of smart live-view video;
transmitting smart live-view video from the camera to the video recorder; and
at the video recorder, displaying only the visible pixels in its displaying video window on monitor screen.

20. Another method to produce the smart live-view video, comprises:
at video recorder, generating and constantly updating the controlling parameters such as the pan offset, tilt offset, zoom ratio, the displaying video window size, and the visibility of pixels in displaying video window are generated and constantly updated based system settings and operator's input;
sending the controlling parameters in upstream signal from the video recorder to the smart live-view processor in each camera;
at the ePTZ controller, selecting a portion of frame picture in digital raw video to be converted into the frame picture of displayed video, which is to be displayed in its video window on monitor screen, regardless of the visibility of the displayed pixels;
at the ePTZ controller, horizontally shifting the selected portion of frame picture in digital raw video depending on the pan offset included in controlling parameters;
at the ePTZ controller, vertically shifting the selected portion of frame picture in digital raw video depending on the tilt offset included in controlling parameters;
at the ePTZ controller, scaling the selected portion of frame picture in digital raw video into the size of its displaying video window depending on the zoom ratio and the size of its displaying video window included in controlling parameters;
at the live-view masking block, replacing the pixel value of invisible pixels with specific pattern, such as a constant 0, and mark the visible pixels and the invisible pixels as active pixels;
at the live-view encoder, encoding all active pixels including the visible pixels and invisible pixels by adopting a lightweight compression algorithm, including but limited to lossless DPCM, lossy DPCM, lossless JPEG or lossy JPEG, to reduce the bit rate of the smart live-view video;
transmitting smart live-view video from the camera to the video recorder; and
at the video recorder, discarding pixel value of invisible pixels carried in smart live-view video and displaying only the visible pixels in its displaying video window on monitor screen.
